(19) United States
(12) Patent Application Publication
(10) Pub. No.: US 2008/0295750 A1
(43) Pub. Date: Dec. 4, 2008

(54) Apparatus And Method For Furrow Opening Using A Disc

(76) Inventor: David Gregor, Queensland (AU)

Correspondence Address: BIO INTELLECTUAL PROPERTY SERVICES (BIO IPS) LLC, 8509 KERNON CT., LORTON, VA, 22079, US

(21) Appl. No.: 10/572,633

(22) PCT Filed: Sep. 20, 2004
(86) PCT No.: PCT/AU2004/001276

§ 371 Date: Aug. 18, 2008

(30) Foreign Application Priority Data
Sep. 19, 2003 (AU) 2003905117

(51) Int. Cl. A01B 49/06; A01C 5/06

(52) U.S. Cl. 111/164; 111/186

(57) ABSTRACT

There is proposed a novel furrow opening apparatus (10) that includes toothed discs (12 and 14) that are able to penetrate the soil thereby creating a furrow (114). The teeth (20) of the apparatus (10) are configured to prevent hair pinning of plant material within the furrow (114). The edges of the teeth (20) slice any plant material as teeth (20) penetrate the soil. Uncut straw is wedged between the teeth (20) and broken by tension as the discs (12 and 14) diverge and any uncut straw is removed from the furrow (114) by teeth (20). Any soil and plant material that adheres to the teeth (20) is cleared by a scraper (48) and deposited back on the soil surface. The apparatus (10) may further include a seeding device (142) that is configured to follow the toothed discs (12 and 14) and create a seeding furrow (166).

### BACKGROUND OF THE INVENTION

There are various forms of furrow openers used in agriculture to sow seed and deposit fertilizers into the soil. Some are in the form of shovel or knife implements which are drawn through the soil. Other openers incorporate concave or flat discs that are pulled behind machinery at an angle to the direction of travel. The discs of such openers bite into the soil and produce a furrow by displacing the soil laterally. Seed is then deposited in the furrow and a subsequent disc covers the seed with soil.

Shovel and knife type openers often require ground cover to be burnt for proper operation and all types of furrow openers cause substantial disturbance to the soil surface, which can increase the likelihood of erosion by wind and water. The soil disturbance poses significant erosion problems in arid or wet environments.

In an attempt to alleviate these potential problems, various reduced tillage techniques have been developed including double and single disc furrow openers. Double disc openers, which have an axis of rotation at a very slight angle to the direction of travel, have been developed to minimise soil disturbance. These openers produce a furrow by cutting a groove in the soil by way of two paired discs. Single disc openers by contrast require the disc to be set at a larger angle to the direction of travel thereby increasing the width of the groove produced. The angle of the single disc however increases the power required to pull such implements behind machinery, applies side loads to the machine frame and can cause a net lateral displacement of soil.

Double disc openers are therefore seen to have distinct advantages over the single disc opener since less power is required in producing a viable furrow and there is less soil disturbance. Having said this, conventional double disc openers also have a number of limitations including the compaction of the floor of the furrow which hampers root elongation in the crop seedlings. The lack of tillage below the seed zone is believed to be one of the reasons why fungal diseases such as rhyzoctonia occur in agricultural crops. Furthermore, the configuration of conventional double disc openers necessitates a large downward force for the opener to penetrate the soil, since the discs form a longitudinally extending wedge at the point of entry into the soil.

Another limitation with the conventional double disc opener is that during operation straw is often pushed into the seed furrow. This is known as hair pinning and can result in the subsequently sown crop being affected by phytotoxins. Phytotoxins are compounds produced through the process of plant decomposition which can inhibit the growth of other plants. Hair pinning can also result in incomplete furrow closure that may further decrease the fecundity of the crop.

Yet another disadvantage with conventional double disc openers is the placement of fertilizer in close proximity to seed. A lack of separation between the seed and fertiliser can result in concentrations of fertiliser that are toxic to the germinating seed.

The potential of straw and plant material blocking the apparatus is also a significant problem in the operation of conventional furrow openers. A blockage can prevent the production of a viable furrow. Furthermore, a blockage increases the power required to pull the disc apparatus through the soil. This causes considerable inconvenience to the user and can increase operational costs.

It is an object of the present invention to provide an apparatus and method for furrow opening using a furrow opener that overcomes at least some of the aforementioned problems or provides the public with a useful alternative.

It is yet a further object of the present invention to provide for a furrow opener that reduces the likelihood of hair pinning and other problems associated with conventional furrow opening apparatus.

### SUMMARY OF THE INVENTION

Therefore in one form of the invention there is proposed an apparatus for furrow opening in soil including:

a first disc having a blade with an outer perimeter that includes a plurality of symmetrical teeth;
a second analogous disc operatively coupled to said first disc; and
wherein said first and second discs are configured to incise and progressively widen a furrow in said soil thereby minimising soil disturbance.

In a further form of the invention there is proposed an apparatus for furrow opening in soil including:

a first disc configured to rotate around a first axis of rotation, said first disc includes a blade outwardly extending from said first axis of rotation, wherein said blade has an outer perimeter includes a plurality of analogous outwardly extending teeth;
a second analogous disc operatively coupled to said first disc and configured to rotate around a second axis of rotation, said second disc mirrors said first disc along a central line of symmetry which is substantially parallel to the direction in which said apparatus travels when a furrow is being created; and
said apparatus includes a leading edge and a trailing edge, wherein said teeth of said first and second discs are in closer proximity at said leading edge than at said trailing edge.

Preferably, said axes of rotation of said first and second discs are substantially perpendicular to the direction of travel of said apparatus.

Preferably, said first and second disc discs are mounted so as to upwardly and rearwardly diverge from each other.

Preferably, said teeth on the perimeter of the first disc abut the teeth on the perimeter of the second disc at a lower vertical position approximating the soil entry point.

Preferably, a scraping assembly is associated with the opening disc apparatus to dislodge any soil or straw that adheres to the said first and second discs during operation.

Preferably, said first and second discs are configured to rotate in unison wherein said teeth on said first disc aligns with said teeth on said second disc.

Preferably, said first disc moves independently from said second disc.

In yet a further form of the invention there is proposed an apparatus for furrow opening in soil including:

a fertiliser furrow opener adapted to create a fertiliser furrow, said fertiliser furrow opener having a first and second disc that include a plurality of teeth;
at least one fertiliser outlet adapted to dispense fertiliser;
a seeding implement having a seeding wheel with an outer circumference that includes a plurality of teeth adapted to create a seeding furrow;
at least one seed outlet adapted to dispense seed; and
at least one depth determining apparatus adapted to govern the depth of said fertiliser furrow and said seeding furrow.

Preferably, said apparatus for furrow opening includes a gear mechanism configured to mechanically couple between said seeding implement and said fertiliser furrow opener.

Preferably, said teeth of said first and second discs are analogous.

Preferably, said teeth of said seeding wheel are analogous.

Preferably, said fertiliser outlet is adapted to dispense fertiliser into said furrow created by said fertiliser furrow opener.

Preferably, said seeding wheel is adapted to partially fill the furrow created by said fertiliser furrow opener and then create said seeding furrow into which seed, dispensed from said seed outlet, is deposited.

Preferably, said apparatus includes at least one press wheel adapted to cover said seed with soil.

In still a further form of the invention there is proposed a method for creating a seed furrow in soil using a furrow opener having a first and second disc, said method includes the steps of:

moving said furrow opener across the surface of said soil, whereby said furrow opener incises the surface of said soil; and
allowing said first and second discs to rotate, wherein said first and second discs are configured to incise and progressively widen said furrow as said furrow opener is moved over the surface of said soil. This is to minimise soil disturbance by the furrow opener.

Preferably, said first and second discs rotate about axes of rotation that are substantially perpendicular to the direct of travel of said furrow opener.

Preferably, more than one pair of said discs is attached to an agricultural implement.

Preferably, the depth to which said discs penetrate said soil can be adjusted.

### BRIEF DESCRIPTION OF THE DRAWINGS

The accompanying drawings, which are incorporated in and constitute a part of this specification together with the description, serve to explain the advantages and principles of the invention. In the drawings,

FIG. 1 is a perspective view of a furrow opening assembly embodying the present invention;

FIG. 2 is a side view of furrow opening assembly of FIG. 1;

FIG. 3 is a perspective view of the discs and depth wheel of FIG. 1;

FIG. 4 is a side view of the discs and depth wheel of FIG. 1 illustrating the relative positions of the teeth on the discs;

FIG. 5 is a perspective view of the furrows that are created by the furrow opening assembly of FIG. 1 illustrating the depositing of fertiliser or seeds into the furrow;

FIG. 6 is a perspective view of a second embodiment of the furrow opener of the present invention illustrating the attachment of a seeding arm;

FIG. 7 is a side view of the furrow opener of FIG. 6 illustrating the depositing of seed and fertiliser into the furrow;

FIG. 8 is a top view of the furrow opener of FIG. 6;

FIG. 9 is a perspective view of the seeding wheel of FIG. 6 as it enters the furrow created by the furrow opener;

FIG. 10 is a perspective view of the furrow opener of FIG. 6 illustrating the attachment of a grader type blade;

FIG. 11 is a perspective view of a third embodiment of the furrow opener of the present invention;

FIG. 12a is a side view of the furrow opener of FIG. 11; and

FIG. 12b is a cross-sectional view between points A and B of the furrow opener of FIG. 12a.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

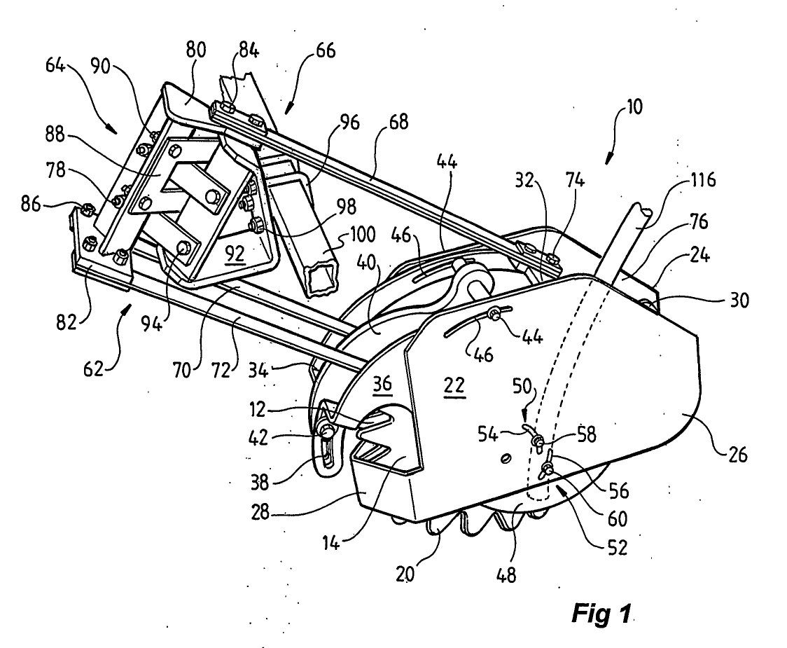

Referring to the drawings for a more detailed description, a furrow opening assembly 10 is illustrated in FIG. 1, demonstrating by way of example one arrangement in which the principles of the present invention may be employed. As illustrated in FIG. 1, the present invention of a furrow opening assembly 10 comprises a pair of opposing discs 12 and 14. The discs 12 and 14 include symmetrical teeth 20. The discs 12 and 14 are rotatably mounted to leg 40. In is envisaged that the discs 12 and 14 will be mounted to the shield 22 using a sealed bearing (not shown), however, it should be appreciated that any form of mounting apparatus can be used providing it does not foul during operation of the apparatus 10.

As illustrated in FIG. 1 the shield 22 includes sides 24 and 26, front guard 28 and beams 30 and 32 that extend between sides 24 and 26. The shield 22 includes arms 34 and 36 which extend forwardly from sides 24 and 26. The arms 34 and 36 include slits 38. A leg 40 is secured to the arms 34 and 36 by way of a bolt and nut arrangement 42. The adjustment device 40 is secured to the sides 24 and 26 by way of bolts 44 which engage slits 46. Slits 46 are used to change the orientation of the discs 12 and 14 to adjust where the teeth 20 abut around the perimeter of discs 12 and 14.

The furrow opening assembly 10 includes depth wheels 48 that are rotatably mounted to the shield 22 and located between sides 24 and 26 and discs 12 and 14. The depth wheels 48 are used to control the depth to which teeth 20 penetrate the soil when creating a furrow. The depth wheels 48 are able to be adjusted by way of adjustment means 50 and 52 to modify the depth of the furrow. In the present embodiment the adjustment means 50 and 52 are in the form of slits 54 and 56 and bolts 58 and 60. However, the skilled addressee should appreciate that the present invention is not limited to this particular configuration. A screw arrangement could alternatively be used to adjust the position of the depth wheels 48.

Apparatus 10 includes a mounting device 62 that is used to flexibly connect the apparatus 10 to a piece of conventional agricultural machinery or an agricultural implement (not shown) for the purposes of conforming to changes in ground surface elevation and to enable the furrow opening assembly 10 to pass over obstacles without damage. The mounting device 62 includes a clamp 64 and a pivot assembly 66 and is connected to the shield 22 by way of three springs 68, 70 and 72. Spring 68 is attached to beam 32 by way of a bolt and nut arrangement 74. Springs 70 and 72 are connected to brackets (not shown) that are attached to the inner surface 76 of sides 24 and 26. Alternatively, springs 70 and 72 are attached to the inner surface 74 of sides 24 and 26 by a conventional method, such as riveting.

The clamp 64 includes a V-shaped bracket 78 that extends between an upper plate 80 and a lower plate 82. The V-shaped bracket 78 is welded to plates 80 and 82. Upper plate 80 is connected to shaft 68 by way of a bolt and nut arrangement 84. Likewise, lower plate 82 is connected to shafts 70 and 72 by way of a bolt and nut arrangement 86. The pivot assembly 66 includes two C-shaped springs 88 that are attached to V-shaped bracket 78 by way of bolt and nut assemblies 90. The terminal ends of the C-shaped springs 88 are attached to the D-shaped bracket 92 of the pivot assembly 66 by way of bolt and nut arrangements 94. In the present embodiment two U-bolts 96 engage the D-shaped bracket 92 and are secured by nuts 98. The U-bolt 96 secures a beam 100 which is connected to a piece of modern machinery (not shown). It is envisaged that the beam 100 of the machinery is able to be moved in the vertical plane so that the apparatus 10 can be elevated from the ground during transportation. The skilled addressee should however appreciate the present invention is not limited to this particular mounting device 62. The mounting device 62 could simply be a bracket (not shown) that is used to secure the apparatus 10 to the piece of machinery or an agricultural implement.

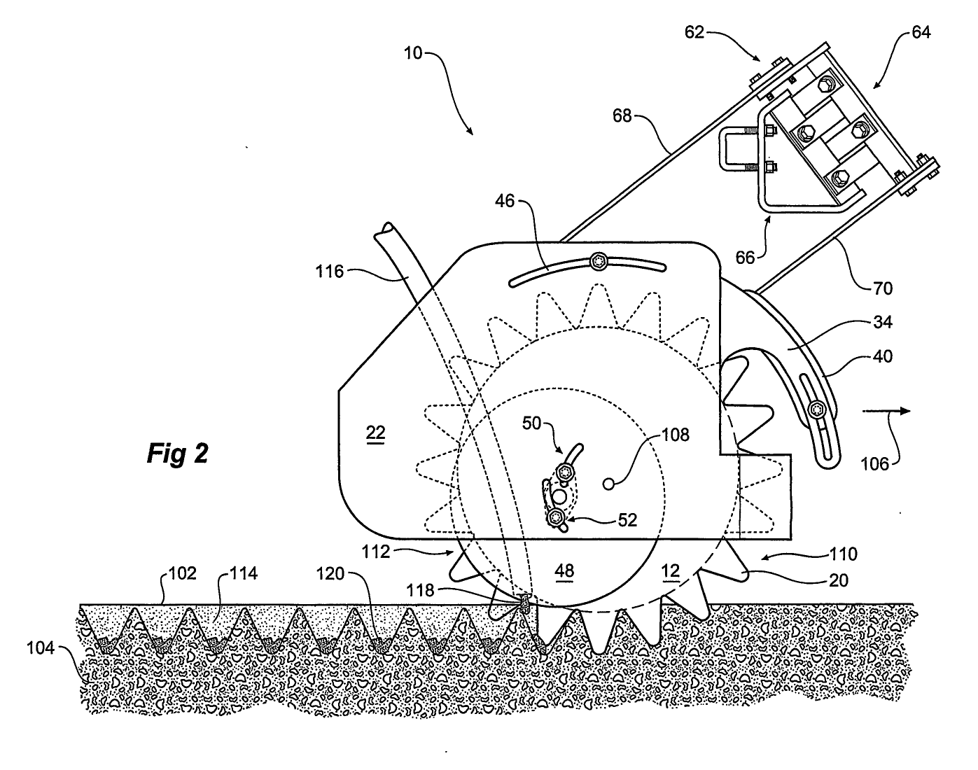

Turning to FIG. 2, as the apparatus 10 travels across the surface 102 of the soil 104 in the direction of arrow 106 the teeth 20 of discs 12 and 14 penetrate the soil 104. The discs 12 and 14 rotate about axis 108 that is substantially perpendicular to the direction of travel 106 of the apparatus 10. As the teeth 20 of rotating discs 12 and 14 move from a leading edge position 110 to a trailing edge position 112 furrows 114 are created in the soil 104. It should be understood by the reader that a plurality of disc assemblies 10 could be fitted to a single agricultural implement thereby forming adjacent rows.

In the present embodiment, as illustrated in FIG. 2, the furrow opening assembly 10 includes an outlet or feeding pipe 116. The outlet pipe 116, which is connected to a supply source (not shown) is configured to dispense fertiliser or seed 118 into furrow 114. Due to gravity the dispensed material 118 collects at the bottom 120 of the furrows 114. In this way seed or fertiliser 118 can be deposited in the soil 104 at a preferred depth. The outlet pipe 116 may include a mechanism (not shown) that pulses the material 118 being dispensed in phase with the furrows 114 or a suitable levelling attachment (not shown) to displace soil and seed from the mounds between furrows into the furrow bottoms. This would reduce any wastage of material 118 that may become lodged on the soil surface 102 between the furrows 114.

Although the furrow opening assembly 10 of the present embodiment includes an outlet pipe 116 it should be appreciated by the reader that the present invention is not limited to a furrow opener 10 that includes an outlet pipe 116. The furrow opener 10 can simply be used in conjuncton with seeding or fertilising equipment to clear and sever stubble to make a path for a seeding or fertilising arm. In this way the present invention 10 could be attached to conventional machinery and agricultural implements to alleviate the problems associated with a build up of stubble around the seeding or fertilising arms.

The furrow opening assembly 10 can also be used solely as a type of tillage implement or it can be used to preform tillage below the seed zone which helps to control fungal disease such as rhyzoctonia that can occur because of the action of presently available double disc openers.

One of the limitations with presently available double disc openers is that because of the circular shape of the discs, any straw or stubble that is caught in front of the discs is forced down into the furrow and left behind when the disc opener advances-forward. This process is commonly referred to as ‘hair pinning’ and can result in damage through phytotoxin effects to the crop that is subsequently sown.

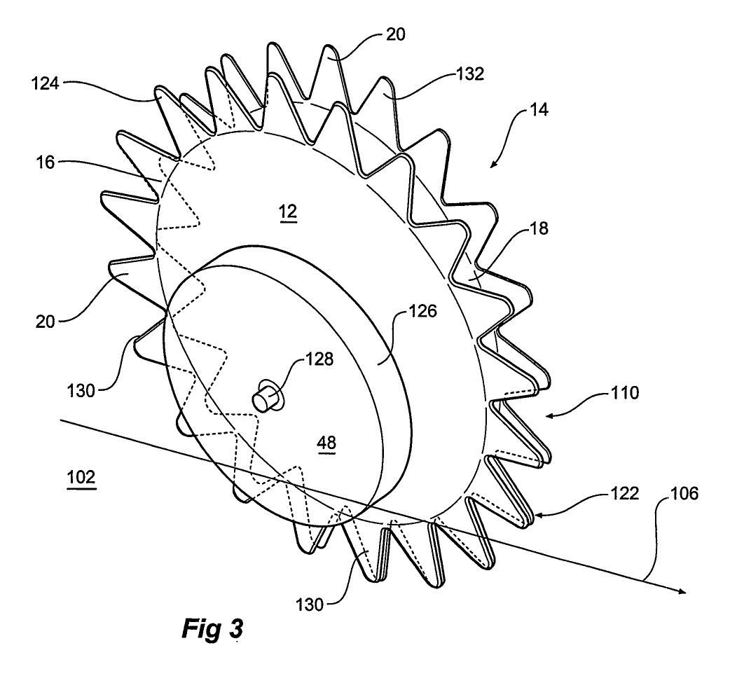

The configuration of the present invention overcomes the problems of hair pinning as well as dealing with the problem of blockage of the disc assembly 10 by plant matter. As illustrated in FIG. 3, the teeth 20 of the discs 12 and 14 are constructed with contoured or arcuate ends 122 to deflect straw and plant material thereby reducing ‘hair pinning’ in furrow 114. Furthermore, the teeth 20 are constructed with sharp chamfered edges 124 that cut any plant material as it travels away from the contoured ends 122 of the teeth 20. Any straw that is still uncut is carried out of the furrow 114 by the teeth 20 and cannot therefore damage the crop though phytotoxin effects.

Typical dimensions of the teeth 20 are a height of some 60 mm, a width at their base of 45 mm and some 10 mm across their front edge, however, it should be appreciated that the teeth 20 are not limited to these dimensions.

As illustrated in FIG. 3, the depth wheel 48 of the present embodiment is in the form of a discus 48 which includes a tread 126 that extends around the perimeter of the discuss 48. The discuss 48 rotates around a hub 128. The tread 126 travels across the soil surface 102 thereby governing the depth to which teeth 20 penetrate the soil. Alternatively, the depth wheel 48 can be in the form of a caterpillar track (not shown) that includes a series of sprockets and a tread made up of multiple linkages.

The depth wheel 48 is also configured to dislodge any soil that adheres to the discs 12 and 14 during opening of the furrow 114. Sticky soil, as they are commonly referred to, can restrict the discs 12 and 14 from rotating and can generally impede the effectiveness of the furrow cutting implement 10. This is particularly relevant where the soil water content is greater than 30% w/v moisture. The hub 128 of the depth wheel 48 is offset from the axis of rotation 108 of the discs 12 and 14 so that as the teeth 20 move from a leading edge position 110 to a trailing edge position 112 the treat 126 contacts the outer surface 130 of teeth 20. In this way any soil or plant material that has adhered to the discs 12 and 14 is dislodged.

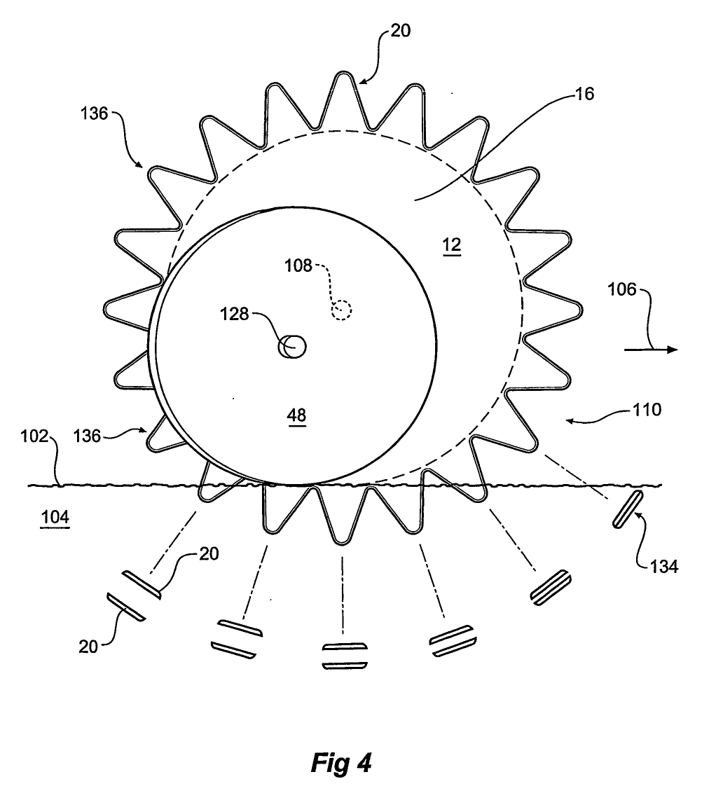

Turning now to FIG. 4, there is illustrated a side view of the discs 12 and 14 illustrating the relative positions of the teeth 20 as they rotate from a leading edge position 110 to a trailing edge position 112. As is illustrated in FIG. 4 the teeth 20 of discs 12 and 14 are parallel to each other and abut each other at a lower vertical point 134 than the axis of rotation 108 of the discs 12 and 14. It is envisaged that the abutment point 134 will be located in close proximity to where the teeth 20 enter the soil 104. However, the skilled addressee should understand that the present invention is not limited to such a configuration. The point 134 where the teeth 20 fully abut could alternatively be at a lower or higher vertical position of the disc assembly 10 or any other configuration sufficient to achieve the cutting of a furrow 114.

As the teeth 20 rotate from a leading edge position 110 to a trailing edge position 112 the distance between the teeth 20 of disc 12 and the teeth 20 of disc 14 increases. The distance between the teeth 20 on respective discs 12 and 14 progressively increases to point 136 where the distance is at its greatest. The distance then progressively decreases as the teeth 20 continue to rotate until they are once again in position 134.

By having point 134, where the teeth 20 abut, located towards the leading edge 110 of the disc assembly 10 as is illustrated in FIG. 4 the teeth 20 are exactly mated as they enter the soil 104. This means that minimum down-pressure is required to cut and compact a furrow 114. Furthermore, the configuration of the disc assembly 10 means that the teeth 20 grip plant material and break it through tension as the teeth 20 of the paired discs 12 and 14 diverge as they rotate towards point 136.

It is to be understood by the reader that the teeth 20 of opposing discs 12 and 14 do not always have to abut each other fully. Alternatively, the teeth 20 can partially abut, generally at the tip of the teeth 20 thereby forming a V-shaped cutting point (not shown).

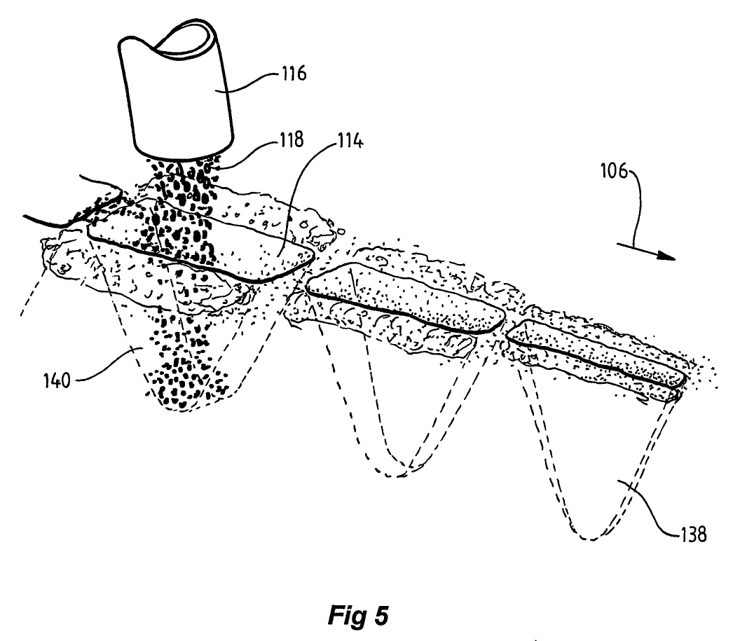

FIG. 5 illustrates the relative sizes of the furrow 114 as one of the teeth 20 moves from a first position 138 which is towards the leading edge 110 of the apparatus 10 to a second position 140 which is towards the trailing edge 112 of the apparatus 10. The angles of the discs 12 and 14, which diverge upwardly away from each other in a vertical plane towards the trailing edge 112, means that the furrow 114 is progressively wedged apart as the apparatus 10 is moved in the direction of travel 106. This allows the seed or fertilizer 118 to be deposited into a furrow 114 that is wider than that which was cut by the teeth 20 at the leading edge 110 of the apparatus 10.

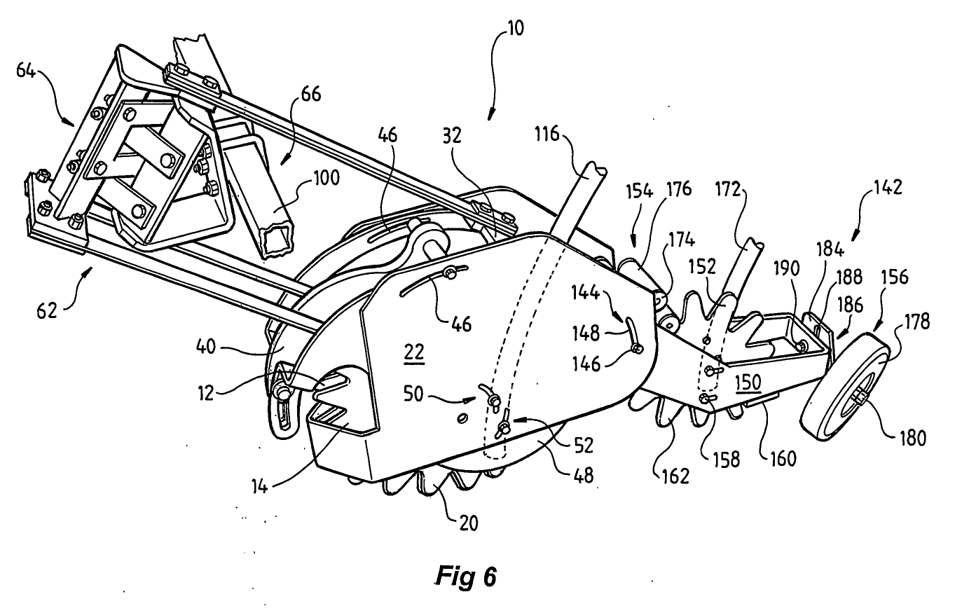

In a second alternate embodiment, as illustrated in FIG. 6, the furrow opening apparatus can include a seeding device 142. The seeding device 142 is attached to the shield 22 by way of connection means 144 which in the present embodiment is in the form of a bolt 146 that engages a slit 148. In this way the seeding device 142 can be adjusted in relation to the shield 22. The seeding device 142 includes a seeding arm 150, a seeding wheel 152, a gear mechanism 154 and a press wheel 156. The seeding arm 150 includes adjustment means 158 for the fine adjustment of the seeding device 142 and a scraper 160 that dislodges any soil that adheres to the seeding wheel 152 during operation.

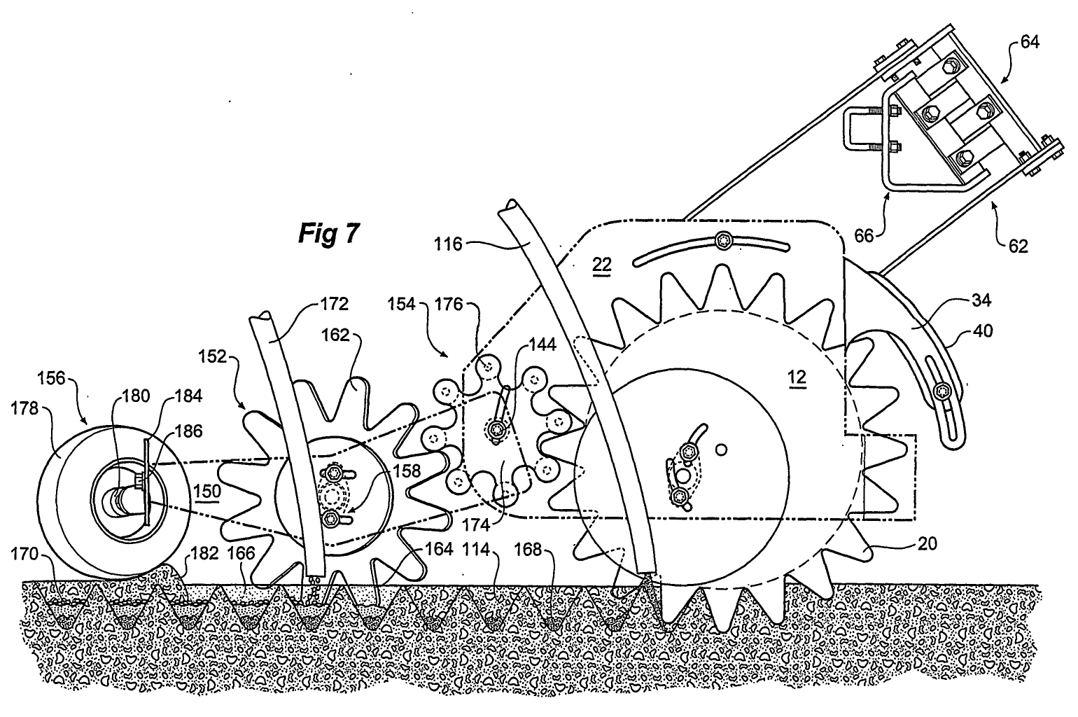

The seeding wheel 152 includes a plurality of symmetrical outwardly extending teeth 160 which are positioned around the outer perimeter of the seeding wheel 152 as illustrated in FIG. 7. It should be understood that the teeth 160 have a due purpose, acting both to partially fill 164 the furrow 114 cut by discs 12 and 14 and to create a viable seed furrow 166. In this way fertiliser 168 can be deposited into furrow 114 and covered by the action of the seeding wheel 152. The teeth 162 then create a seeding furrow 166 into which seed 170, dispensed from outlet pipe 172, can be deposited. This enables the seed 170 to be separated from the fertiliser 168 which overcomes the problems associated with the toxic effects on germinating seed 170 of high concentrations of fertiliser 168. It is envisaged that the fertiliser furrow 114 will be approximately 75 mm deep and the seed furrow 166 will be approximately 10-50 mm deep. This will provide at least a 25 mm separation between the seed 170 and the fertiliser 168. It should however be appreciated that the present invention is not limited to furrows 114 and 166 of this particular depth as the seeds of different crops will require different germination conditions.

As further illustrated in FIG. 7, the apparatus 10 includes a gear mechanism 154 which links discs 12 and 14 to the seeding wheel 152. In the present example the gear mechanism 152 includes a frame 174 and a plurality of rollers 176 which are configured to engage the teeth 20 of discs 12 and 14 and the teeth 162 of seeding wheel 152. In this way the discs 12 and 14 drive the rear seeding wheel 152. It should however be appreciated that the present invention in not limited to rollers 176, any gear mechanism 154 could be for, for example a simple chain and cog device (not shown) could be used.

The press wheel 156 of the present embodiment includes a pneumatic type 178 which rotates around hub 180. The press wheel 156 is configured to completely fill 182 the seed furrow 166 thereby covering seed 170. It should however be appreciated that any type, of blade or wheel could be used to move the soil into the seed furrow 166.

The press wheel 156 is attached to bracket 184 which is adjustably attached via connection means 186 to the seeding arm 150. The adjustable connection means 186 of the present embodiment includes a slit 188 and bolt and nut arrangement 190, as illustrated in FIG. 6.

The depth to which the teeth 162 of the seeding wheel 152 penetrate the soil is determined by the position of the depth wheel 48 and the press wheel 156. The seeding arm 150 can be adjusted in relation to the press wheel 156 by way of the adjustable connection means 186. This thereby adjusts the depth of the seeding furrow 166. Adjustment can also be achieved through connection means 144 and adjustment means 158.

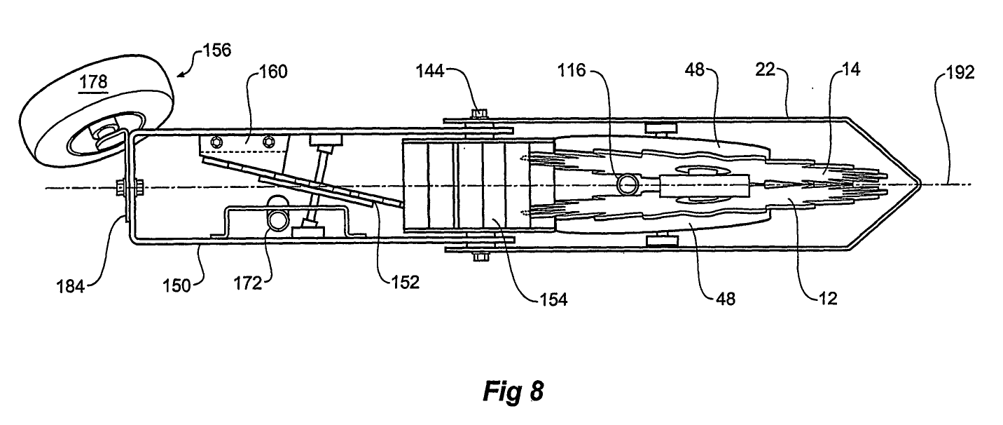

As illustrated in FIG. 8, the seeding wheel 152 is at an angle to the vertical line of symmetry 192 which corresponds to the direction of travel. This ensures that the teeth 162 of the seeding wheel 152 contact the edge of the fertiliser furrow 114 created by discs 12 and 14. In this way the seeding wheel 152 is able to partially fill 164 furrow 114, whist still being able to create a viable seeding furrow 166. The press wheel 156 is likewise offset from the line of symmetry 192 to enable the tyre 178 to transfer soil into the seeding furrow 166 thereby covering the seed 170. It may be desirable to have a press wheel 156 on either side of the vertical line of symmetry 192 at the rear of the seeding arm 150 to transfer soil from either side into the furrow 166.

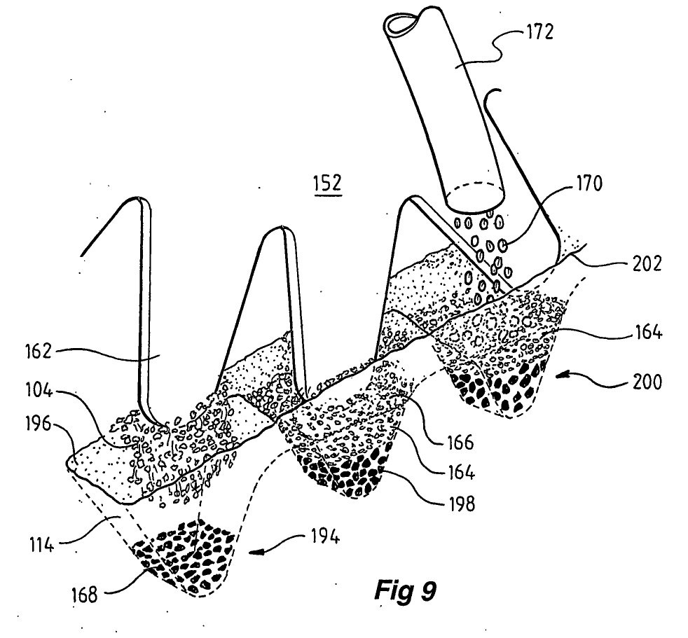

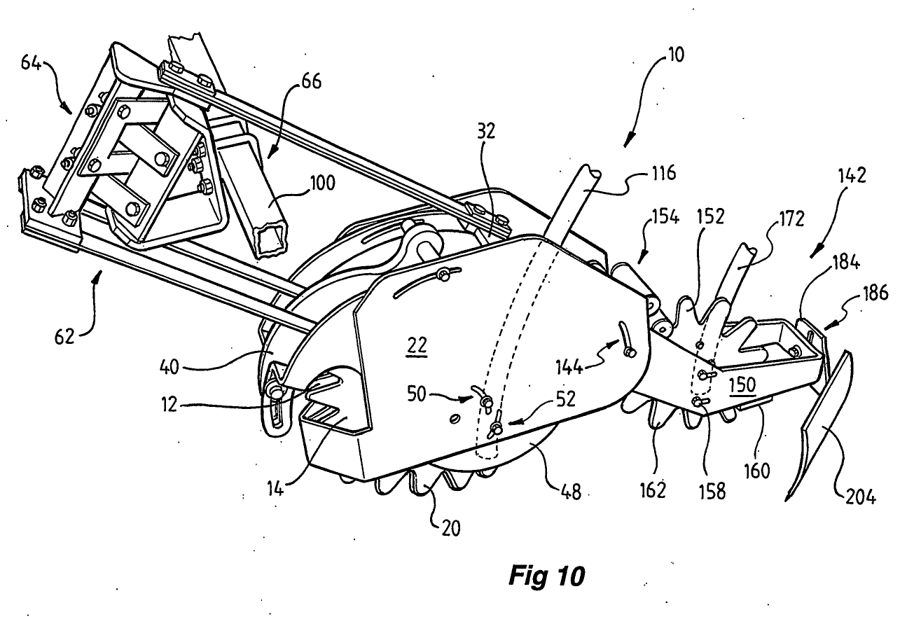

FIG. 9 illustrates the action of the teeth 162 of the seeding wheel 152 as they initially enter 194 the fertiliser furrow 114 which has been created by discs 12 and 14. The teeth 162 contact the edge 196 of the furrow 114 and dislodge some of the soil 104 which falls into the bottom of the furrow 114 thereby covering the fertiliser 168. As the teeth 162 move into a second position 198 they compress the soil which has been dislodged from the side 196 of the furrow 114 thereby forming a seeding furrow 166. The teeth 162 then move into a third position 200 wherein seed is deposited into the furrow 166 by outlet pipe 172. In this way the seed is separated from the fertiliser 168 by a layer of soil 164. In this third position 200 the teeth 162 contact the side 202 of the furrow 166 which results in the soil collapsing into the furrow 166 thereby partially covering the seed 170. The press wheel 156, as illustrated in FIG. 6, then completely covers the seed 170 with soil. Alternatively, a grader blade 204, as illustrated in FIG. 10, can be used to move the soil into the seed furrow 166 thereby completely covering the seed 170.

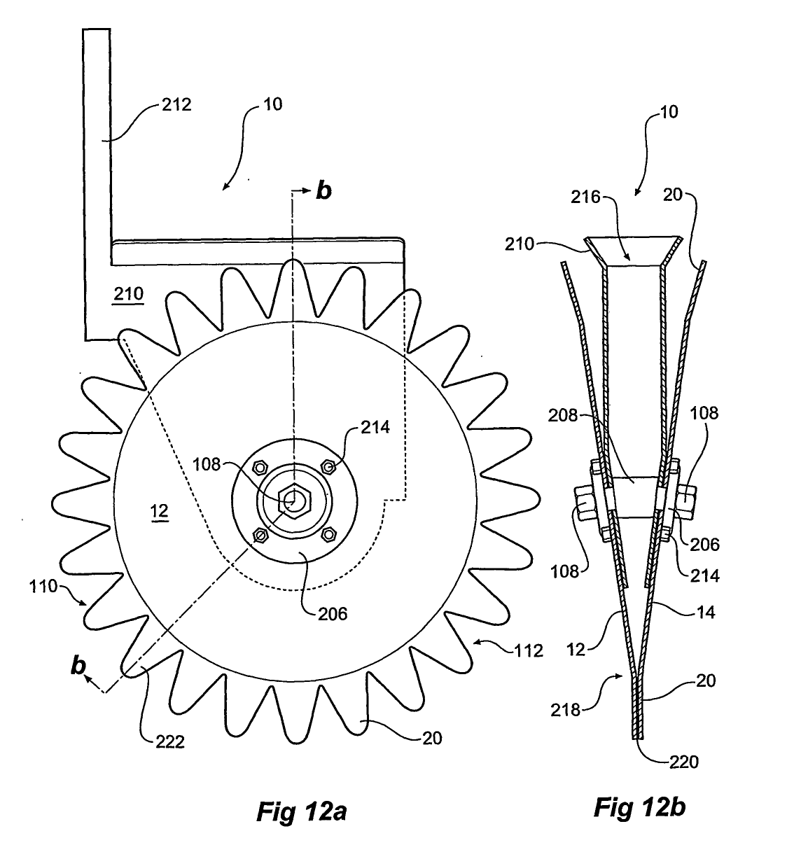

In a third embodiment the furrow opening apparatus 10 includes discs 12 and 14 which are rotatably mounted on a bearing cap 206, a bearing housing 208 (as illustrated in FIG. 12b) a seed or fertiliser boot 210 and a mounting bracket 212 which is configured to be attached to a piece of agricultural machinery or agricultural implement (not shown).

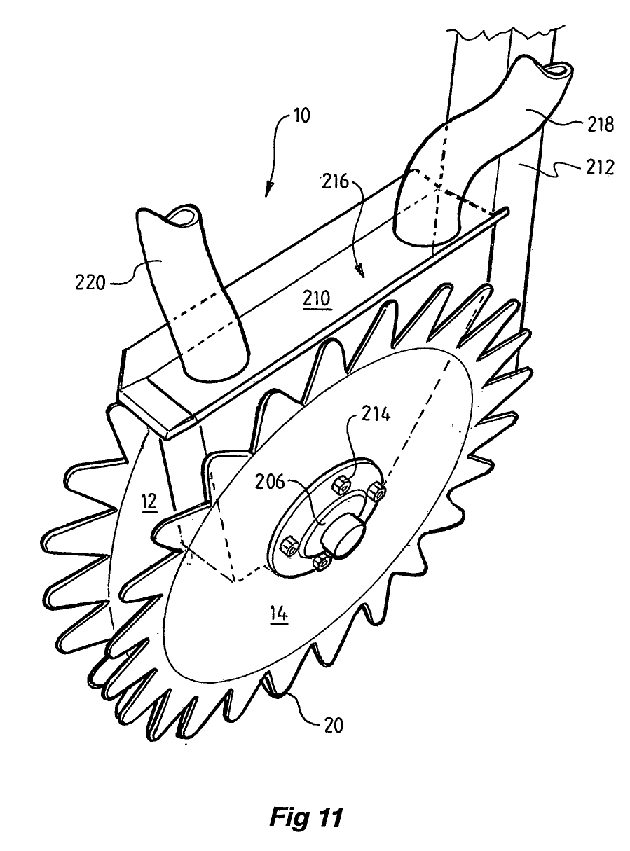

The discs 12 and 14 are secured to the bearing cap 206 by a plurality of rivets or bolts 214. The discs 12 and 14 are able to rotate in relation to the seed boot 210, in a manner well known in the art. The seed boot 210 incorporates a funnel shaped duct 216 through which seed and fertiliser can be deposited into the furrow cut by the discs 12 and 14. The seed boot 210 illustrated in FIG. 11 incorporates a fertilizer delivery tube 218 towards the front of the duct 210 and a seed delivery tube 220 at the rear of the duct 210. However, it should be understood by the reader that the invention is not limited to such a configuration. A tube or pipe could alternatively be used to deposit the seed and fertiliser directly into the furrow created by the discs 12 and 14, with the use of a funnel shaped duct 210.

Turning finally to FIGS. 12a and 12b, there is illustrated a side view and a cross-sectional view of the furrow opener 10 of the third embodiment. FIG. 12b shows the cross-section between points A and B of FIG. 12a. As illustrated in FIG. 2b the discs 12 and 14 are positioned at an angle from each other to form a V-shaped cutting point 218. The outwardly extending teeth 20 of the analogous discs 12 and 14 are parallel to each other and abut 220 each other at a lower vertical point 222 than the axis of rotation 108 of the discs 12 and 14, as illustrated in FIGS. 2a and 2b. As further illustrated in FIG. 2b the discs 12 and 14 diverge upwardly from each other in the vertical plane. It is to be understood that the teeth 20 of opposing discs 12 and 14 do not always have to abut fully against each other and can partially abut, generally at the tip of the teeth 20 thereby facilitating the penetration of the teeth 20 into the soil. In the present example, as illustrated in FIG. 12a, the point 222 where the teeth 20 of the two discs 12 and 14 fully abut 220 is towards the leading edge 110 of the disc assembly 10, as illustrated in FIG. 2a.

Although the invention has been described as being used for the addition of seed and fertiliser into soil it should be appreciated by the reader that the invention is not limited to this use. The present invention could be used to insert any horticultural substance, such as granular polymers for moisture retention, into soil or existing turf.

The skilled addressee will now appreciate that the present invention provides a novel furrow opening apparatus 10. The configuration of the disc assembly 10 of the present invention overcomes the limitations of currently available disc openers and other agricultural implements. The teeth of the disc assembly 10 provide tillage below the seed zone and their configuration reduces the likelihood of hair pinning of plant material within the furrow, thereby reducing fungal disease and phytotoxic effects that influence the fecundity of the crop. Furthermore, the furrow opening apparatus 10 is able to be used in conjunction with conventional agricultural machinery.

The tips of the teeth of the present invention deflect straw instead of pushing it further into the soil. The edges of the teeth slice the straw as it is deflected away from the tips. Uncut straw is wedged between teeth and are broken in tension by the divergence of the discs. Any further uncut straw is removed from the furrow by the teeth, cleared by a scraper, and deposited back on the soil surface. As the reader will now appreciate the configuration of the disc assembly 10 reduces the likelihood of the hair pinning and the resultant phytotoxic effects on the crop subsequently sown.

The apparatus 10 can further include a seeding device having a toothed seeding wheel. In this configuration, fertiliser is deposited into the first furrow which is created by the action of a duel disc apparatus. The first furrow is then partially filled by the following seeding wheel which is also configured to create a second furrow into which seed is deposited. The seed is then covered with soil by the action of a press wheel or grader blade. As the reader will appreciate this configuration provides a furrow opening device that is able to deposit seed and fertiliser at predetermined depths thereby averting the toxic effects associated with high concentration of fertiliser in close proximity to seed. The depths of the furrows are able to be adjusted depending on the crop that is being sown and the desired separation between the seed and fertiliser.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In the summary of the invention and the claims, except where the context requires otherwise due to express language or necessary implication, the word “comprising” is used in the sense of “including”, i.e. the features specified may be associated with further features in various embodiments of the invention.

1. An apparatus for furrow opening in soil including:
a first disc having a blade with an outer perimeter that includes a plurality of symmetrical teeth;
a second analogous disc operatively coupled to said first disc; and
wherein said first and second discs are configured to incise and progressively widen a furrow in said soil thereby minimising soil disturbance.

2. An apparatus for furrow opening in soil including:
a first disc configured to rotate around a first axis of rotation, said first disc includes a blade outwardly extending from said first axis of rotation, wherein said blade has an outer perimeter includes a plurality of analogous outwardly extending teeth;
a second analogous disc operatively coupled to said first disc and configured to rotate around a second axis of rotation, said second disc mirrors said first disc along a central line of symmetry which is substantially parallel to the direction in which said apparatus travels when a furrow is being created; and
said apparatus includes a leading edge and a trailing edge, wherein said teeth of said first and second discs are in closer proximity at said leading edge than at said trailing edge.

3. An apparatus for furrow opening in soil as in any of the above claims wherein said axes of rotation of said first and second discs are substantially perpendicular to the direction of travel of said apparatus.

4. An apparatus for furrow opening in soil as in any of the above claims wherein said first and second disc discs are mounted so as to upwardly and rearwardly diverge from each other.

5. An apparatus for furrow opening in soil as in any of the above claims wherein said teeth on the perimeter of the first disc abut the teeth on the perimeter of the second disc at a lower vertical position approximating the soil entry point.

6. An apparatus for furrow opening in soil as in any of the above claims wherein a scraping assembly is associated with the opening disc apparatus to dislodge any soil or straw that adheres to the said first and second discs during operation.

7. An apparatus for furrow opening in soil as in any of the above claims wherein said first and second discs are configured to rotate in unison wherein said teeth on said first disc aligns with said teeth on said second disc.

8. An apparatus for furrow opening in soil as in any of the above claims wherein said first disc moves independently from said second disc.

9. An apparatus for furrow opening in soil including:
a fertiliser furrow opener adapted to create a fertiliser furrow, said fertiliser furrow opener having a first and second disc that include a plurality of teeth;
at least one fertiliser outlet adapted to dispense fertiliser;
a seeding implement having a seeding wheel with an outer circumference that includes a plurality of teeth adapted to create a seeding furrow;
at least one seed outlet adapted to dispense seed; and
at least one depth determining apparatus adapted to govern the depth of said fertiliser furrow and said seeding furrow.

10. An apparatus for furrow opening in soil as in claim 9 wherein said apparatus for furrow opening includes a gear mechanism configured to mechanically couple between said seeding implement and said fertiliser furrow opener.

11. An apparatus for furrow opening in soil as in claim 9 wherein said teeth of said first and second discs are analogous.

12. An apparatus for furrow opening in soil as in claim 9 wherein said teeth of said seeding wheel are analogous.

13. An apparatus for furrow opening in soil as in claim 9 wherein said fertiliser outlet is adapted to dispense fertiliser into said furrow created by said fertiliser furrow opener.

14. An apparatus for furrow opening in soil as in claim 9 wherein said seeding wheel is adapted to partially fill the furrow created by said fertiliser furrow opener and then create said seeding furrow into which seed, dispensed from said seed outlet, is deposited.

15. An apparatus for furrow opening in soil as in claim 9 wherein said apparatus includes at least one press wheel adapted to cover said seed with soil.

16. A method for creating a seed furrow in soil using a furrow opener having a first and second disc, said method includes the steps of:
moving said furrow opener across the surface of said soil, whereby said furrow opener incises the surface of said soil; and
allowing said first and second discs to rotate, wherein said first and second discs are configured to incise and progressively widen said furrow as said furrow opener is moved over the surface of said soil.

17. An apparatus for furrow opening in soil as in claim 16 wherein said first and second discs rotate about axes of rotation that are substantially perpendicular to the direct of travel of said furrow opener.

18. An apparatus for furrow opening in soil as in claim 9 wherein more than one pair of said discs is attached to an agricultural implement.

19. An apparatus for furrow opening in soil as in claim 9 wherein the depth to which said discs penetrate said soil can be adjusted.

20. An apparatus for furrow opening in soil substantially as herein before described with reference to FIGS. 1-5.

21. An apparatus for furrow opening in soil substantially as herein before described with reference to FIGS. 6-10.

22. An apparatus for furrow opening in soil substantially as herein before described with reference to FIGS. 11-12b.
